(19) United States
(12) Patent Application Publication
(10) Pub. No.: US 2015/0085290 A1
(43) Pub. Date: Mar. 26, 2015

(54) FLUID ANALYSIS

(71) Applicant: FRAS Technology, Øvre Årdal (NO)

(72) Inventor: Sølve Fjerdingstad, Kolbotn (NO)

(21) Appl. No.: 14/398,350

(22) PCT Filed: May 3, 2013
(86) PCT No.: PCT/EP2013/059295

§ 371 Date: Oct. 31, 2014

(30) Foreign Application Priority Data
May 3, 2012 (NO) 20120511
May 3, 2012 (NO) 20120512

(51) Int. Cl. G01N 21/49; G01N 21/05

(52) U.S. Cl. CPC G01N 21/49; G01N 21/05; G01N 2201/08; G01N 2201/06113; G01N 2201/0697
USPC 356/445

(57) ABSTRACT

The embodiments herein relate to a system (100) for analyzing a fluid (103). The system (100) comprises a light source (110) configured to emit light for transmission through a first optical transmission means (107a) to a measurement device (105). The measurement device (105) comprises at least a part of the fluid (103) and is configured to be illuminated by the emitted light. The system comprises a second optical transmission means (107b) configured to transmit shadowed or reflected light from the fluid (103) when the measurement device (105) is illuminated to an image capturing device. The image capturing device (113) is configured to capture an image of the fluid (103) in the measurement device (105) based on the transmitted information about the fluid (103). The light source (110) and the one or more image capturing device (113) are remotely arranged from the at least one measurement device (105).

### TECHNICAL FIELD

The embodiments herein pertain to the field of fluid analysis, more specifically fluid analysis thanks to the use of a light source. The embodiments herein also pertain to the field of fluid measurement, analysis and monitoring, more specifically to an inline or in-situ fluid measurement and monitoring arrangement.

### BACKGROUND

It has always been a challenge to monitor the condition of a large machine installation, comprising several machinery with different hydraulic systems, gearboxes and lubrication systems.

Particle counting has been used to give an early warning looking at different signs of wear from particles, leakages (water), chemical or biological contamination in the hydraulic or lubrication fluid. Due to poor sampling procedures and apparatus, inadequate particle counting system and lack of interpretation competence by involved personnel, particle counting has had a limited usage. Instead, vibration analysis has been used to see the development of wear and tear of machinery, although breakdown and wear would have been seen long before through particle analysis. One of the limitations with instruments used is that the instrument only counts particles. Necessary information to determine is among others the shape and origin of the particles. Particles from hard alloys, steel and sand will give a huge difference in secondary wear and damage than water droplets air bubbles or biofilm, but they will be counted and reported the same way.

The weakness of the above technology has been seen by the US Navy, and a research program was formed at the end of the nineties by the Naval Research Laboratories producing the LASERNET analyser. The method looks at visible contamination in the oil by using image analysis and photo/video technology. By pulsing laser light through an optical flow cell, the instrument takes a high frequency of pictures per minute of particles passing the flow cell, stores the pictures in a database which compare pictures with known wear particles from machinery and reporting type and quantity of particles present in the oil. This method, when employing a reliable fluid sampling system provides reliable and repeatable measurements opening for online monitoring. However, even this method has limitations. On a ship, on an oil platform or in a process factory, there will always be variation in oil reservoirs, gear boxes, oil qualities etc. Therefore it is not easy to use the same instrument to follow up several machines. Setting up a condition monitoring system with an analysing box on each machine would also be expensive, and follow-up and maintenance demanding. The cost of instrumentation can become repelling, and follow-up and maintenance demanding. In a highly flammable environment, all electronics could potentially cause explosions. It is therefore important not to expose highly flammable liquids or potentially explosive environments to electronic circuits and power supplies.

To analyse impurities, particles and foreign fluids in a flowing fluid, the use of a by-pass for sampling and/or analysing is known, the by-pass being generally of a smaller diameter than the main flow line. Such solution may allow for a continuous by-pass circulation in order to obtain a representative sample of the fluid, measuring the by-passed fluid continuously in a measurement cell installed on the by-pass circuit, or isolating the representative sample in a sampling chamber which in turn is extracted for analysis in another location, typically a laboratory. FIG. 4 illustrates such a representative method for sampling in a sampling bottle 401. The fluid flows into the device 400 illustrated by the arrow 403 and out of the device 400 illustrated by arrow 405. The device 400 comprises a connector block 408 with a retractable ball valve. The device 400 also comprises two shut-off valves, a downstream valve 410 and an upstream valve 413. The device 400 comprises a screwable quick disconnector 415 which can be operated even at high pressure. A pressure balancing channel 418 equalizes pressure inside and outside of the sampling bottle 401. The pressure vessel is represented with the reference number 420. The device 400 comprises a unloading channel 423 and a unloading valve 425. It is described in for example WO2004/057306 A1 or WO2008/111851 A1. Alternatively, the sampling chamber may feed automatically a measurement cell.

The fluid, for example a heavy machinery lubrication oil, can e.g. be analysed by for example a LASERNET FINES® analyser developed by the United States Naval Research Laboratory. This analyser looks at visible contamination by particles using image analysis and photo/video technology. By pulsing laser light through an optical flow cell, the instrument takes pictures at high frequency of the fluid passing the flow cell, stores the pictures in a database which compare pictures with known wear particles from machinery and reporting type and quantity of particles present in the fluid.

When no sampling is required, it would be beneficial to be able to avoid the by-pass arrangement made of pipes, connections, sampler, accessories, control system and a necessary connection for fluid inlet and outlet to the by-pass, affecting the integrity of the main fluid pressure piping—for illustration, a lubrication fluid loop can be submitted to pressure of over 700 ba—. A by-pass circuit includes at times many connections, each of which represents a possible source of leakage. Furthermore, even when a by-pass is part of the design, a cell built “in-line” in the by-pass may prove advantageous. The by-pass itself may still be of a relatively large diameter and otherwise require a secondary by-pass, and the issue of representativity of the fluid analysed needs a good solution.

Meanwhile, it is generally not possible to analyse fluid across the whole piping due to large diameters, and a thin analysis flow cell may be required for a good quality fluid analysis. It may be a thin and flat measurement cell, such as in the LASERNET FINES® or it may be a cylindrical cell. By standards initially developed for aeronautics (NAS1638), heavy machinery lubrication fluid circuits are monitored for particles less than a 100 μm. Cells with its smallest width (rectangle opening) or diameter of 100 μm placed in a flowing fluid have shown to be too small for the fluid to flow in the cell: surface and capillary tensions can be too high to overcome, and the fluid at best does not have a stable flow within the flow cell, at worst does not flow through at all. These small size flow problems can be observed for larger diameter, up to one mm, and even several mm.

### SUMMARY

It is an object of the embodiments herein to solve the multiplication of analysers by centralising emission and analysis of the measurement signals thanks to multiplexing of signal transmitted in fibre optic cables.

Another object of embodiments herein is to allow installing an analyser far from the measurement cell, thus allowing measuring fluids in an environment not compatible with the analyser.

Another object of the embodiments herein is to enable a special packaging for the measurement cell so as to allow its use in difficult environment.

Another object of embodiments herein is to allow particle analysis, fluid analysis and machine monitoring in inflammable or explosive environments safer and cheaper.

It is an object of the embodiments herein to use particle analysis of lubrication and/or cooling fluids as the prime source for condition monitoring of heavy machinery.

Yet another object of the embodiments herein is to allow the detection of subsea leakages. By using fiber optic cables in combination with optical multiplexers, it is possible to move and integrate the measurement device to the machinery a whole different way, the installation will be much more robust and one single instrument can be used to perform analysis independently of which machine the analysis is performed at, the type of oil and the surrounding environment. Problems with explosive gases near the instruments will disappear thanks to fibre optic cables transmitting emitted laser light to the measurement device and using optics and fibre cables to return images back to image analysis in the instrument which is located into a safe area.

According to a first aspect, the object is achieved by a system for analyzing a fluid. The system comprises a light source configured to emit light for transmission through a first optical transmission means to at least one measurement device measurement device. The at least one measurement device measurement device comprises the fluid and is configured to be illuminated by the emitted light. The system comprises a second optical transmission means configured to transmit shadowed or reflected light from the fluid when the measurement device measurement device is illuminated to at least one image capturing device. At least one of the light source and the image capturing device are remotely arranged from the measurement device measurement device.

In some embodiments, the image capturing device is configured to capture an image of the fluid in the measurement device measurement device based on the transmitted information about the fluid.

In some embodiments, the system comprises an analysing device configured to analyse the captured image thereby obtaining information about the fluid.

In some embodiments, the at least one measurement device is a flow cell connected to at least one machine comprising the fluid, and the fluid comprised in the machine is bypassed through the at least one measurement device.

In some embodiments, the at least one measurement device comprises a first part to which the first optical transmission means is connected and through which the emitted light is further transmitted when the at least one measurement device is illuminated.

In some embodiments, the first part is a first transparent sheet.

In some embodiments, at least a part of the first optical transmission means and at least a part of the second optical transmission means comprises at least one optical fiber cable.

In some embodiments, the emitted light travels through the fluid when illuminating the at least one measurement device, and the information about the fluid is based on a property of the emitted light when travelling through the fluid.

In some embodiments, the fluid comprises particles and wherein the information about the fluid comprises information about a number of particles and/or impurities in the fluid and/or the type of particles in the fluid.

In some embodiments, the fluid is a liquid or a gas.

In some embodiments, the one or more image capturing device comprises one image sensor associated with each optical fiber cable adjusted to capture shadowed or reflected light transmitted through the associated optical fiber cable and assigning the captured shadowed or reflected light to the measurement device from which the shadowed or reflected light is transmitted.

In some embodiments, the one or more image capturing device comprises one High Definition image sensor divided into a number of spatial areas respectively associated with an optical fiber cable being arranged so that the associated spatial area only captures shadowed or reflected light transmitted through the optical fiber cable and assigning the captured shadowed or reflected light to the measurement device from which the shadowed or reflected light is transmitted.

In some embodiments, the at least one optical fiber cable is provided with an optical switch being synchronized with the frame rate of the one or more image capturing device, the optical switch is switched on only when the one or more image capturing device is capturing a certain frame in an array of captured frames during an image capturing cycle, and the captured image data in the certain frame only comprises image data of shadowed or reflected light transmitted through the optical fiber cable, which is being assigned to the measurement device from which the shadowed or reflected light is transmitted. A frame rate may also be referred to as a frame frequency and may be described as the frequency or rate at which an image capturing device produces unique consecutive images called frames.

In some embodiments, the measurement device comprises a flow cell formed with a fluid inlet and a fluid outlet through which at least a part of the fluid flows in and out, a flow restriction arrangement whereby, the flow restriction arrangement is configured to generate an increased head-loss between the fluid inlet and the fluid outlet, and wherein the measurement device is connected to the first optical transmission means configured to transmit light emitted from a light source to pass through at least a section of the fluid flowing through the flow cell and connected to the second optical transmission means at least one optical receiving element configured to receive the light after passing through the fluid in flow cell and configured to transmit the received light so that the fluid can be analysed.

According to a second aspect, the object is achieved by a method for analyzing a fluid, the method comprising:
emitting light from a light source;
transmitting the emitted light through a first optical transmission means to at least one measurement device, which at least one measurement device comprises the fluid;
illuminating the at least one measurement device with the transmitted light; and
transmitting shadowed or reflected light from the fluid when the measurement device is illuminated to an image capturing device using a second optical transmission means;
wherein at least one of the light source and the image capturing device are remotely arranged from the measurement device.

In some embodiments, the image capturing device is configured to capture an image of the fluid in the measurement device based on the transmitted shadowed or reflected light from about the fluid.

In some embodiments, the captured image is analyzed with an analyser thereby obtaining information about the fluid.

In some embodiments, the at least one measurement device is connected to at least one machine comprising the fluid, and wherein the fluid comprised in the machine is bypassed through the at least one measurement device.

In some embodiments, the at least one measurement device comprises a first part to which the first optical transmission means is connected and through which the emitted light is further transmitted when the at least one measurement device is illuminated.

In some embodiments, the first part is a first transparent sheet.

In some embodiments, at least a part of the first optical transmission means and at least a part of the second optical transmission means comprises at least one optical fiber cable.

In some embodiments, the one or more image capturing device comprises one image sensor associated with each optical fiber cable adjusted to capture shadowed or reflected light transmitted through the associated optical fiber cable and assigning the captured shadowed or reflected light to the measurement device from which the shadowed or reflected light is transmitted.

In some embodiments, the one or more image capturing device comprises one High Definition image sensor divided into a number of spatial areas respectively associated with an optical fiber cable being arranged so that the associated spatial area only captures shadowed or reflected light transmitted through the optical fiber cable and assigning the captured shadowed or reflected light to the measurement device from which the shadowed or reflected light is transmitted.

In some embodiments, the method further comprises the following steps:
synchronizing an optical switch with which at least one optical fiber cable is provided with the frame rate of the one or more image capturing device;
switching on the optical switch only when the one or more image capturing device is capturing a certain frame in an array of captured frames during an image capturing cycle of the one or more image capturing device; and
assigning the measurement device from which the shadowed or reflected light is transmitted to the captured image data in the certain frame.

In some embodiments, the emitted light travels through the fluid when illuminating the at least one measurement device, and wherein the information about the fluid is based on a property of the emitted light when travelling through the fluid.

In some embodiments, the fluid comprises particles and wherein the information about the fluid comprises information about a number of particles in the fluid and/or the type of particles in the fluid.

According to a third aspect, the object is achieved by a computer program stored in a computer readable memory and comprising instructions to execute the above mentioned method.

It is also an object of the embodiments herein to allow inline measurement, analysis and monitoring in a fluid thanks to one or several measurement arrangements positioned in the flowing fluid and generating head-loss in order to allow sufficient pressure differential between both ends of the measurement arrangement for the fluid to flow in a stable manner in the measurement arrangement. It has been observed that without such head-loss generation, the flow in the measurement arrangement was either non-existent, or not stable enough.

Another object is to have a robust measurement solution not requiring a by-pass system, and not affecting the physical integrity of the main conduit.

Another object is to have a measurement solution with a representative sample of the fluid to measure in its measurement arrangement. The measurement arrangement is positioned in the fluid stream of the main conduit, more representative than what a by-pass would collect.

Another object is to be able to use this measurement arrangement for foreign particle and fluid analyses of lubrication and/or cooling fluids of heavy machinery for monitoring purposes.

Another object is to allow an easy installation method of one or several inline measurement arrangements in a fluid pipework not requiring welding operations. Note that such inline measurement arrangement may be installed in a by-pass. A by-pass may still be of large diameter, for which an inline representative cell to measure is advantageous. And in any piping, by-pass or not, a representative measurement cell to analyse is required.

According to a fourth aspect, the objects are achieved by an apparatus for analysing a fluid flowing through a conduit. The apparatus is located within the conduit. The apparatus comprises a flow cell formed with a fluid inlet and a fluid outlet through which at least a part of the fluid flows in and out. The apparatus comprises a flow restriction arrangement whereby, the flow restriction arrangement is configured to generate an increased head-loss between the fluid inlet and the fluid outlet. The apparatus further comprises at least one optical transmission element configured to transmit light emitted from a light source to pass through at least a section of the fluid flowing through the flow cell and at least one optical receiving element configured to receive the light after passing through the fluid in flow cell and configured to transmit the received light so that the fluid can be analysed. In some embodiments, at least a part of the flow restriction arrangement is connected to the flow cell. In some embodiments, at least a part of the flow restriction arrangement is connected to the conduit. In some embodiments, the flow restriction arrangement comprises at least one of a plate and/or at least one spring-loaded device. In some embodiments, the flow restriction arrangement comprises a restriction of an inner diameter of the conduit. In some embodiments, the head-loss generated is in the range of 0.3 to 0.5 ba. In some embodiments, the fluid is a liquid or a gas. In some embodiments, the apparatus is made of a material having optical transparent characteristics. In some embodiments, the flow restriction arrangement forms a reduced flow cross-sectional area inside the conduit.

According to a fifth aspect, the objects are achieved by a conduit comprising a fluid and at least one apparatus.

According to a sixth aspect, the objects are achieved by a method for inline analysis of a fluid in a conduit using the apparatus. The apparatus is located in the conduit. The apparatus comprises a flow cell formed with a fluid inlet and a fluid outlet. The apparatus further comprises a flow restriction arrangement, at least one optical transmission element and at least one optical receiving element. The method comprising:
generating an increased head loss between the fluid inlet and the fluid outlet when at least a part of the fluid flows through the apparatus;
transmitting light emitted from a light source through the at least one optical transmission element so that it passes through at least a section of the fluid flowing through the flow cell;
receiving, with the at least one optical receiving element, the light after passing through the fluid in the flow cell; and
transmitting, using the at least one optical receiving element, the received light to an analyser so that the fluid may be analyzed.

The embodiments herein, allowing centralising the light emission and analysis apparatus offer several advantages, of which a non-exhaustive list of examples follows:
Capital costs: Only one apparatus to purchase, and/or replace for a full plant.
Apparatus back-up affordable: only one additional apparatus may need to be purchased.
Operational costs: only one (+back-up) apparatus to calibrate and maintain. If the apparatus needs retrieval down by a well-head, cost consequences are important.
Robustness: the apparatus can be installed in a protected room, far from vibrations, dust, grease, heat, frost . . . .
Safety: no requirement for power connections at the location of the equipment to monitor.
Easy to retrofit: whereas the sampling and measurement cell need to be designed locally, no need to design the analysis apparatus room locally.
Whereas the sampling and measurement cell need to be designed according to local conditions of use, the analyser may be a standard analyser installed in a protected environment.
Safer to use and cheaper to install: The online flow cells may be installed in the piping without requiring welding.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating embodiments of a system

FIG. 2 is a schematic representation illustrating embodiments of the complete monitoring system applied to machine condition monitoring.

FIG. 3 is a schematic representation of an embodiment of spatial multiplexing,

FIG. 4 is a schematic representation of embodiment of a sampling and measurement cell.

FIG. 5 is a schematic representation of an embodiment of a subsea package for an analyser.

FIG. 6 is a schematic representation of an embodiment applied to the detection and estimation of subsea gas leakages, for example above a well-head.

FIGS. 7a-b are schematic representations of the inline measurement arrangement installation.

FIGS. 8a-j are schematic representations of alternative embodiments of measurement arrangement design:
8a with a welded plate on the downstream end of the measurement arrangement,
8b with a section restriction of the conduit about the downstream end of the measurement arrangement,
8c where the measurement arrangement outer shape has a downstream increasing diameter,
8d where head-loss is created about the upstream end of the measurement arrangement thanks to conical segments on the measurement arrangement,
8e where a plate is positioned at the upstream end of the measurement arrangement,
8f where a flange plate is positioned at the upstream end of the measurement arrangement,
8g where a spring loaded conical valve adjusts to the pressure and the flow,
8h and 8i where two spring loaded half-disks are positioned either at the upstream end or the downstream end of the measurement arrangement, and
8j where the flow restriction is positioned somewhere between upstream inlet and downstream outlet, for example in the middle.

FIG. 9a-b are schematic representations of possible transmitted and backscattered measurement configurations:
9a with a single emitting source,
9b with several emitting sources.

FIG. 10 is a schematic representation of a plate-supported configuration with several measurement arrangements, installed between piping flanges.

FIGS. 11a-b are schematic representations of a plate-supported multi-cell configuration with a perforated plate, the flow restriction around each measurement arrangement resulting from the combination of a head-loss unit and the perforation:
11a as a section,
11b as an upstream view.

FIG. 12a-b schematic representation of a plate-supported multi-cell configuration with a perforated plate, the flow restriction resulting from a perforation around each individual measurement arrangement:
12a as a section,
12b as an upstream view.

FIG. 13 is a schematic representation of a plate-supported multi-measurement arrangement configuration with a perforated plate, showing the optical fibres connecting to the measurement arrangement, upstream view.

### DETAILED DESCRIPTION

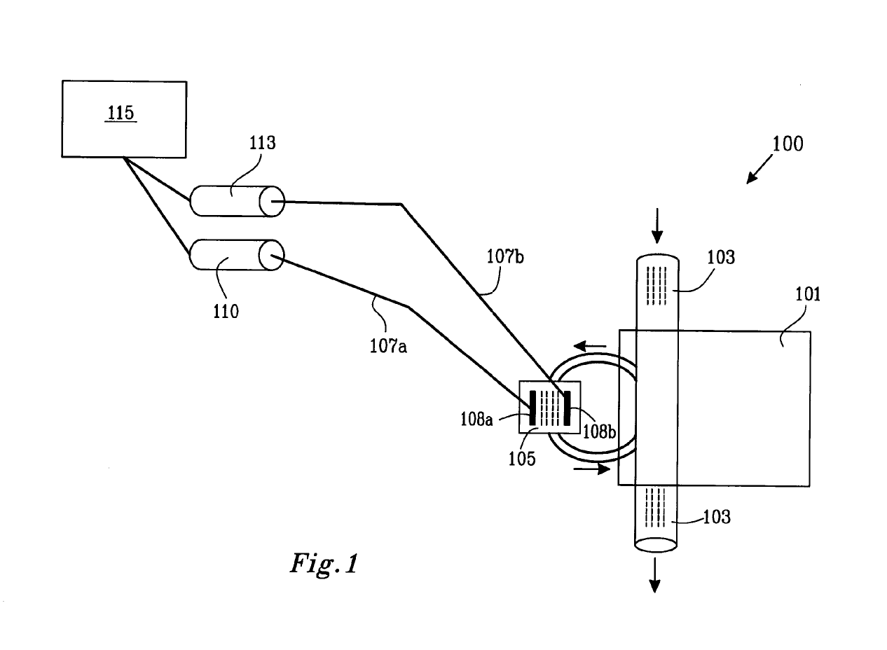

FIG. 1 illustrates embodiments of a system 100 for analyzing a fluid 103. The system 100 comprises a machine 101 in which the fluid 103 is comprised. The fluid 103 may be a liquid or a gas. A measurement device 105 is connected to the machine 101. The measurement device 105 may for example be connected to the outside of the machine 101, for example by bypassing. When bypassing the machine 101, the machine 101 operation continues as normal at the same time as the measurement device 105 is operating, and a pipe or channel is used to create an alternative path for the fluid 103 into the measurement device 105. The fluid 103 is still flowing through the machine 101 at the same time as a part of the fluid 103 is conducted through the measurement device 105. In this example, the system 100 comprises one measurement device 105 and one machine 101, however there may be one measurement device 105 connected to a plurality of machines 101, a plurality of measurement devices 105 connected to one machine 101, or a plurality of measurement devices 105 each connected to a respective machine 101 of a plurality of machines 101.

A first optical transmission means 107a is connected to the measurement device 105 for conveying light emitted from a light source 110 to the measurement device 105, thus illuminating the measurement device 105 and the fluid 103 comprised in the measurement device 105. The light source 110 may be for example a laser configured to emit a laser beam. A second optical transmission means 107b is connected to the measurement device 105 for conveying information about the fluid when the measurement device 105 is illuminated to an image capturing device 113 which captures an image of the fluid 103. At least a part of the first optical transmission means 107a and at least a part of the second optical transmission means 107b comprises an optical fiber cable. In some embodiments, the first optical transmission means 107a and the second optical transmission means 107b is one single cable arranged to convey light in two directions, i.e. to the measurement device 105 and from the measurement device 105. In some embodiments, the first optical transmission means 107a and the second optical transmission means 107b are separate cables. The first optical transmission means 107a and the second optical transmission means 107b have a sufficient length in order for at least one of the light source 110 and the image capturing device 113 to be remotely located from the measurement device 105, i.e. they are non in situ. Remotely may be described as being located far away or that it is far removed.

The distance between the image capturing device 113 and the measuring device 105 may be in the range from a few centimeters in case the image capturing device 113 is mounted on a conduit in which the measuring device 105 is located within, and up to several kilometers where e.g. the image capturing device 113 is located on an offshore platform while the measuring device 105 is located substantially close to the floor of the sea. The distance between the image capturing device 113 and the measuring device 105 is only limited by the reduction of the light in the optical medium and in joints. The reduction per kilometer for ordinary light in optical fibers and cables are typically approximately 3 dB (i.e. the half). In joints, the reductions are approximately 0.1-0.25 dB.

The first optical transmission means 107a and the second optical transmission means 107b may be connected to the same side of the measurement device 105 or on opposite sides of the measurement device 105.

The image capturing device 113 may transmit the captured image to an analyser 115 which is configured to analyze the captured image in order to obtain information about a number of particles, a type of particles, in the fluid 103. The image capturing device 113 may be a camera. The quantity “a number of” also means “a certain quantity” or “a given quantity”. The analyser 115 may also be located remotely from the measurement device 105. The terms analyser and analyzing device may be used interchangeable in this text, and both terms refer to a device which is configured to analyze the captured image in order to obtain information about a number of particles, a type of particles, in the fluid 103.

The measurement device 105 may have any size and shape suitable for conveying the bypassed fluid 103 and suitable for connection to the machine 101. For example, it may have a square shape or a circular shape. The measurement device 105 may be completely or partly closed. The measurement device 105 is open in case of a static measurement cell. The measurement device 105 may be made of a transparent material so that when the emitted light illuminates the measurement device 105, the light passes through the walls of the measurement device 105 and travels further through the fluid 103. If the fluid 103 comprises for example particles, a foreign fluid or any other substance, the emitted light will be reflected. Based on information about the reflected light, the number of particles, the type of particles etc. may be obtained.

In the following, the terms flow cell and measurement cell are used interchangeably and both terms relates to a cell through which the fluid subject to analysis is channeled.

In some embodiments, the measurement device 105 comprises a first part 108a, e.g. a first transparent sheet made of for example glass or of a plastic material and arranged inside of the measurement device 105. The first optical transmission means 107a may be connected to the first part 108a. When the measurement device 105 is illuminated, the light travels through the first part 108a due to its optical transparent characteristics. The light may hit particles in the fluid 103, and reflected back to the first part 108a. The second optical transmission means 107b, which may also be connected to the first part 108a, transmits the reflected light or information about the reflected light to the image capturing device 113.

In some embodiments, the measurement device 105 comprises the first part 108a and a second part 108b, where both parts may be transparent sheets made of for example glass or of a plastic material and arranged inside of the measurement device 105. As exemplified in FIG. 1, the first part 108a and the second part 108b may be arranged vertically and having a distance between them where the fluid 103 may flow. When the light hit particles in the fluid, some light beams may be reflected and only some of the light beams will reach the second part 108b. If the second optical transmission means 107b is connected to the second part 108b, it transmits the light beams which reached the second part 108a or at least information about it to the image capturing device 113.

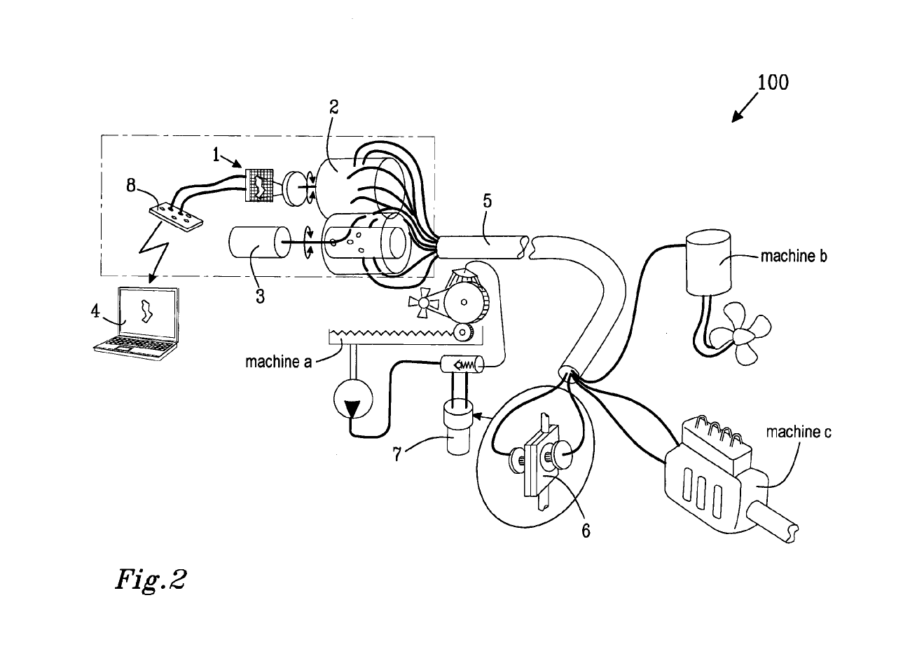

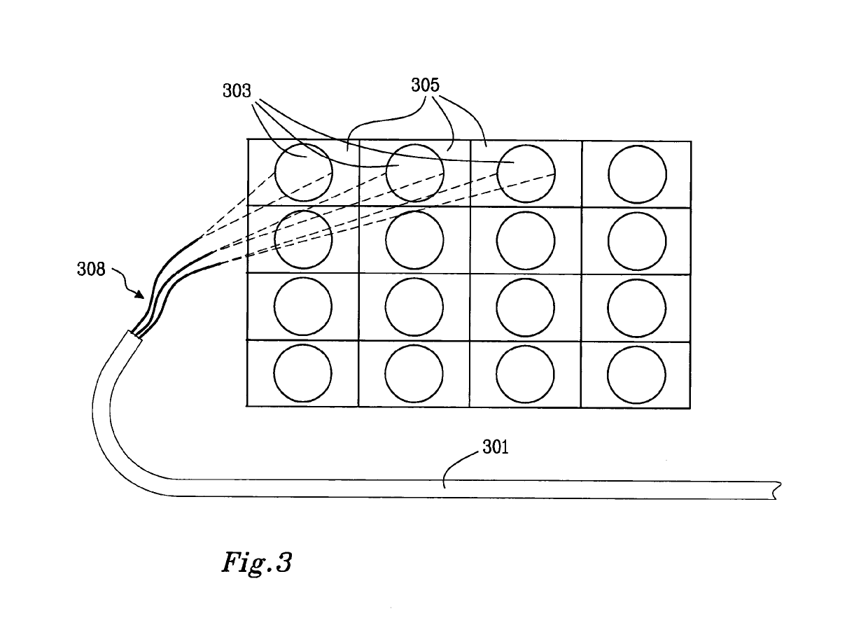

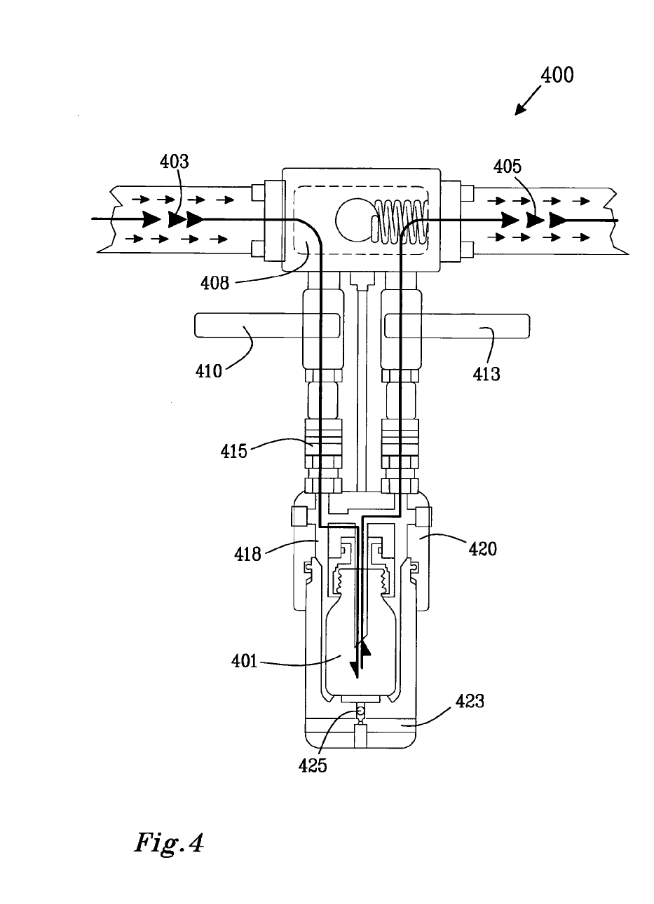

FIG. 2 illustrates an exemplary embodiment of the system 100. A laser beam 3 is emitted from a monitoring centre 4, 8 into a downlink optical multicable 5 comprising a number of downlink optical fibers. The monitoring center 4, 8 may comprise a computer 4 and a controller 8. The downlink optical multicable 5 is wired to a machine comprising a number of components in which liquids require monitoring. The different components of the machine is exemplified in FIG. 2 with machine a, machine b and machine c. One or more of the downlink optical fibers are wired to each of the components machine a, machine b and machine c, more specifically to e.g. a measurement device 6 connected to the component. As mentioned earlier, the measurement device 6 may be a flow cell. Possible characteristics of the measurement device 6 or other optical flow monitoring equipment are described below. In some embodiments, the machine a is equipped with a fluid sampler 7. In the case of a measurement device 6 as illustrated in FIG. 2, the ends of the one or more downlink optical fibers are fixed to the first one of the two sheets of glass of which the measurement device 6 comprises, and are adjusted to direct the laser beam 3 through the liquid flowing through the measurement device 6, hitting the second one of the two sheets of glass. When travelling through the liquid, the light is reflected by possible particles on its way, and is also attenuated depending on the content and characteristics of the liquid in the measurement device 6 by the time the light is passing through.

One or more uplink optical fibers are fixed to the second one (transmitted light) of the two sheets of glass, preferably on line with the one or more downlink optical fibers fixed to the first one of the two sheets of glass adjusted to capture the light emitted from the one or more downlink optical fibers having travelled through the liquid. The one or more uplink optical fibres may be terminated on the measurement device 6 side by respective lenses to better direct the captured light into the fibers. In case the system 100 comprises several measurement devices 6, the uplink optical fibers from several measurement devices are collected into an uplink optical cable, transmitting captured light from the respective measurement devices 6. In this case, the system 100 comprises a fiber optic multiplexer 2. The uplink optical cable is wired to, and is terminated at the monitoring centre 4, 8. At the monitoring centre 4, 8, one or more image sensors 1 are provided, adjusted to capture the light transmitted by the uplink optical cable. The image sensor 1 may be represented by a camera as exemplified in FIG. 2.

Several techniques for distinguishing between the light originating from respective measurement devices in the monitoring centre 4, 8 for further analysis could be used. In one embodiment, there is one image sensor or one camera 1 for each of the group of one or more uplink optical fibres corresponding to a respective measurement device 6. The ends of the one or more uplink optical fibres terminated at the monitoring centre 4, 8 corresponding to a respective measurement device 6 are then positioned to be directed perpendicularly to the dedicated image sensor 1, so that the dedicated image sensor 1 only captures the light transmitted from the respective measurement device 6. The image captured by the image sensor 1 is addressed to the respective measurement device 6, and can be analysed independently from the light captured at the other measurement devices.

In another embodiment, which is illustrated in FIG. 3, the ends of all the uplink optical fibres 301 of the uplink optical multicable terminated at the monitoring centre are positioned to be directed to one area of an image sensor so that the catchment of the respective light 303 transmitted by the respective uplink fibre cables are positioned in dedicated areas 305. This requires a spatial multiplexing of the light captured by the image sensor to address the light from the different measurement devices. As an example, for a High Definition (HD) image sensor, each of the group of one or more of the uplink optical fibers 308 corresponding to respective measurement devices are arranged to be directed to known spatial areas of the High Definition (HD) image sensor. The overall image captured by the HD image sensor will then be a mosaic being compound of images from the different measurement devices. Since the spatial positions associated with the different measurement devices are known, they can easily be separated and analysed independently.

Wave length division multiplexing techniques could also imaginable. In wave length division multiplexing, each light carrier has a dedicated wavelength. When applied in the embodiments herein, the laser light is emitted into the different downlink fibres at different wavelengths. This could be accomplished with one laser beam source for each optical fibre, or one or more laser beam sources and one or more beam splitters, splitting the light into light beams of different wavelength which are directed into the different downlink optical fibres. At the receiving side, only one or at least only a limited number of image sensors is required. Light from more than one measurement device will then hit one image sensor simultaneously, but since they are of different wavelengths, it is possible to separate the images from the different measurement devices by trivial digital post-processing. In addition, each pixel in an image sensor comprises a red, a blue and a green sensor. If the light beams emitted from the light beam source are limited to these wavelengths, no post-processing of the captured image would be required, since an image sensor actually captures three images of red, green and blue color simultaneously.

Time division multiplexing could also be used in the embodiments herein. In this case, the fact that video images contains frames of consecutive images is utilized in combination with some kind of rapid switching of the light from the different uplink fibres so that light from only one optical fibre hits the image sensor at a time. Each optical fibre has one dedicated time frame of the sequential captured time frames captured by the image sensor, e.g. every 6^{th} time frame. These frames would then be extracted from the total array of frames by digital processing, and assembled to one video image. Assuming that the image sensor has the capability for a total frame rate of 60 frames per second, a video image from one measurement device would then have a frame rate of 10 frames per second, which would be an acceptable frame rate for this purpose. The switching of light could be done mechanically, by changing the direction of the ends of the optical fibres of which emitted light respectively hits the image sensor sequentially at a rate corresponding to the frame rate of the image sensor. Optical switches could also be utilised for the same purpose, sequentially switching the light off emitted from all of the optical fibres except from one.

Light emitted from one side and captured on the opposite side of a measurement device as discussed above, only exposes shapes of particles, and some characteristics of transparent liquid. To disclose information about the material characteristics of the particles in the liquid, backscatter needs to be taken into account. This requires that the one or more uplink optical fibres are fixed to the first one of the two sheets of glass, i.e. the same glass to which the one or more downlink optical fibres are fixed. The uplink optical fibres would then be able to capture light reflecting from particles in the measurement device. The wave length of the light captured by the one or more uplink optical fibres would then be used as an indication for determining the type of material in the particles reflecting the light. Further, by arranging the one or more uplink optical fibres so as to have slightly different angles relative to the first one of the two sheets of glass, a 3D image of the backscattering could be provided.

The instrument, in an example embodiment a particle analyser, as described in FIG. 2, produces a laser beam 3 into an optic fibre cable 5 linked to an inlet optical multiplexer 2. A controller 8 will steer the inlet optical multiplexer 2 in order to send the laser light through the optic fibre multiplexer, to the optic fibre multi-cable 5 and to the machine which requires monitoring. The machine a is equipped with a fluid sampler 7 provided with integrated measurement device 6. When monitoring takes place, the laser light is transmitted through the measurement device. The measurement device 6 consists of a frame with two sheets of glass separated by 100 to 1000 micrometer. One or several liquid tube(s) containing the lubricating oil is/are positioned between the two glass plates, and the sampled lubricant flows through the measurement device 6. The necessary oil flow to perform the analysis is created by the pressure drop over the internal check valve in the fluid sampler 7. A fluid sampler 7 is connected to the oil circulation system of each individual machines a, b and c, and the multiplexer 2 will select where to send the laser light for the analysis.

On the other side of the measurement device 6, a lens system will receive picture of the particles. The particle pictures will then be transmitted through an optic fibre cable and back to the analyser where the images are analysed and counted. The same process will take place for each individual machine monitored, and all images can be analysed by a one and single instrument.

The controller 8 and associated computer 4, based on instructions by the operator, a programmed preventive maintenance sequence, or events such a high vibration detection, will manage the whole system. For example, upon programmed monitoring of machine a, the controller 8 will start laser 3 warm-up, then switch laser light to the optic fibre feeding the flow-cell 6 of machine a thanks to the inlet fibre optic multiplexer 2, switch the return signal from the flow-cell 6 to the analyser thanks to the return Fibre optic multiplexer 2, then index, analyse, store and transmits the analysis results. Fibre optic multiplexers 2 are known in the industry, and can be bought off the shelf. Optional to returning the pictures back to the instrument by using fiber cable, each sampling point can have an individual camera video chip connected to the measurement device 6, and transmitting wirelessly results to the analyser thanks to a wireless interface system as available and known in the Telecom industry. This embodiment does not apply to subsea applications.

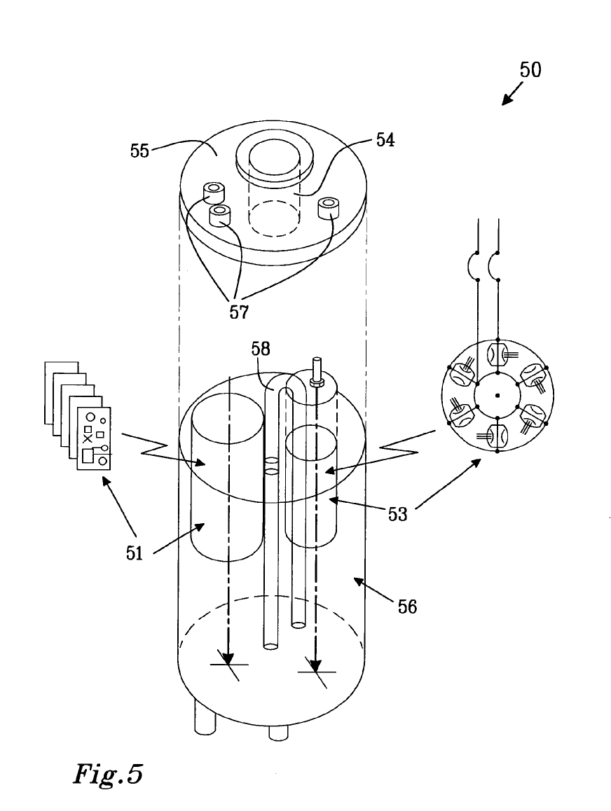

Another embodiment is the monitoring of machinery or hydraulic fluid installations subsea. The new oil and gas fields are being developed in more difficult areas, many of which are offshore, and getting deeper. Oil and Gas subsea installations are developing and multiplying in response of the depth, and they include machinery which sometimes can be very heavy. Maintenance, repair and/or substitution of equipment subsea is expensive and demanding. Being able to plan intervention in advance is of great advantage: it allows planning several interventions when hiring a ROV (underwater Remotely Operated Vehicle). Monitoring and early detection of troubles with machines allows such planning.

Whereas the principles of the embodiments herein are similar to the previous case on a platform, there are some issues related to conditioning of the equipment to high pressure depth. Typically, the analyser will need to be packaged in a pressure compensated container, easily retrievable and substituted with a ROV. An example analyser is shown on FIG. 5. A pressure compensated container 56 comprises a sensor module 53 containing the measurement cell fed by a channel 58, connected to an electronic module 51 for measurement control and optionally analysis. The apparatus is powered by an accumulator 54—it may also be powered thanks to a connection—. The container is closed by a cover 55, supporting the different optional connections 57 for power, data, light (optic fibre), fluids of which the measured fluid etc. . . . . Such container will typically be designed for easy ROV handling, installation and retrieval, thanks to the use of fast connections and easy grip, as known in the art.

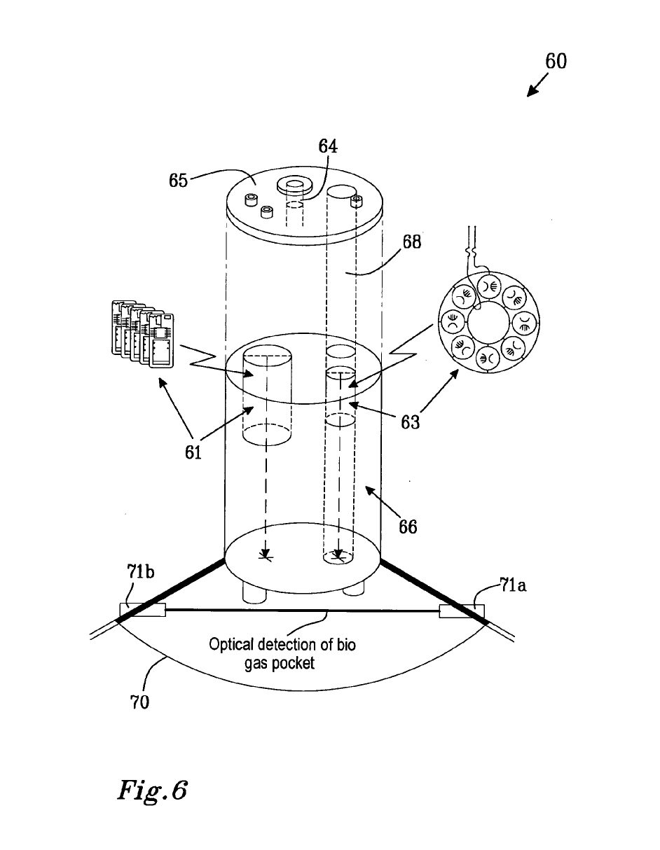

Still another embodiment relates to the detection and analysis of gas leakages for offshore subsea Oil&Gas installations, as exemplified in FIG. 6. Installed in the vicinity of a Christmas tree, blow-out preventer, pipe connection etc. . . . , above the points identified as most risky in terms of leakages, the leakage detector 60 will react upon detection of bubbles flowing through a measurement channel 68, or even substitution of the liquid trapped under the umbrella 70 by gas until the interface gas-seawater reaches the cells 71, for example light cells which will react when the gas substitution allows a direct activation of the receiving cell 71b by the light transmitting cell 71a. The discontinuous line shown in FIG. 6 indicates a through-channel to feed the internal flows cell. The cover 65 will also support the different optional connections for power, data, light (optic fibre), fluids of which the measured fluid etc. . . . . The leakage detector 60 may have in fact two cells, one for blow-outs, and one for routine surveillance. Design for ROV handling will be used. As part of subsea design, the measured fluid channel may be designed such that both inlet and outlet of the measured fluid channel be designed at the bottom of the container, see item 58 in FIG. 5. The leakage detector has the basic units as described above for the subsea analyser: it is made of a pressure compensated container 66 comprising a sensor module 63 containing the measurement cell fed by the channel 68, connected to an electronic module 61 for measurement control and optionally analysis. The apparatus is powered by an accumulator 64—it may also be powered thanks to a connection—.

In cases related to gas leakages/blowout, the analyser will also here be packaged with pressure compensated container, easily retrieved/installed by a ROV.

The transformed light need not be raw, but may be pre-processed at the location of each cell where transformation take place or downstream, between transformation and analysis apparatus. One may for example stack several measured signals, or preprocess between the cell and the analysing instrument.

The liquid monitored can preferably be lubrication or cooling fluid to heavy equipment such as pumps, generators, compressors, turbines, transformers, etc. It may also be the closed loop of a thermal exchanger. The liquid monitored may be the rather static sea water at the sea bottom by a well-head or any other selected location where monitoring gas bubbles is deemed of interest. A gas may also be monitored for particles and droplets, such as exhaust gas, heat exchanges gases.

Whereas the embodiments herein may find its full potential for a plant (platform, ship, process industry . . . ) with many pieces of equipment to monitor, it may solve some issues related to the installation conditions of a sophisticated analysis apparatus, when for example the monitoring environment is rough (dust, vibrations, heat . . . ) or unsafe (explosion risks, radioactivity . . . ), even if only one machine shall be supervised. Whereas the embodiments herein may find its full potential for a subsea hydrocarbon field with many wellheads or critical equipment or locations to monitor, it may solve some issues related to the installation conditions of a sophisticated analysis apparatus, when for example the monitoring environment is not optimal to the installation of the analysis apparatus, for example when it is too rough or not well adapted for ROV substitution of the analysis apparatus.

Results from the analysis can be further sent to a maintenance centre, possibly far from the plant. For example, the plant can be an Oil & Gas offshore platform, and the analysis results can be sent via radio signal to the maintenance centre onshore. Results can trigger alarms, on the plant and in the maintenance centre . . . all known process control can be relevant and implemented in relation with the embodiments herein. An advantage of some of the embodiments, analysing particles in lubrication fluids or bubbles in seabed water, is that monitoring can be preventive: source of potential trouble may be identified before the trouble starts: excessive wear may be detected before it generates vibrations, for example, and excessive bubbling may be detected before a possible blow-out.

Power supply to the analyser may be saved, provided an autonomous local power supply such as a local propeller. Such propeller, in addition to supply power, provides the head loss required to canalise the fluid to the sampling and analysing unit.

This monitoring system applies to all type of analysis and/or monitoring including a source of light—for example a laser—and the analysis of such source of light after its transformation, be it transmission, reflection, diffraction etc. . . . which transformation relates to the material to analyse.

Another embodiment may be flow measurement, such as those based on light.

The embodiments herein also relate to a laser-based particle counting and analysing device for monitoring heavy rotating machines described here below.

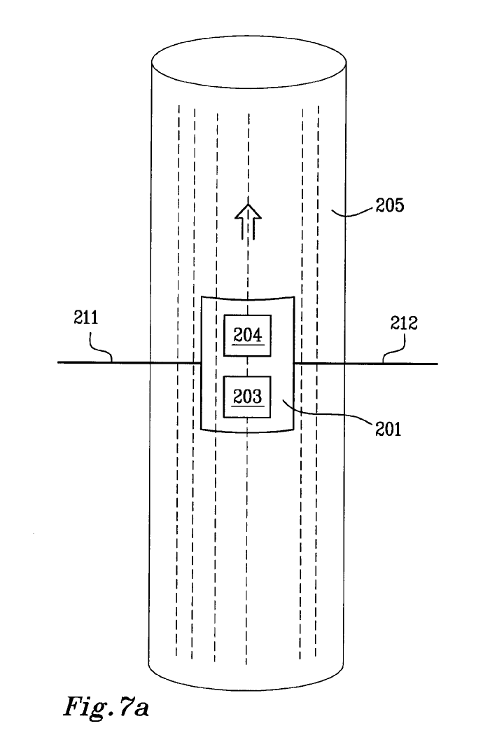

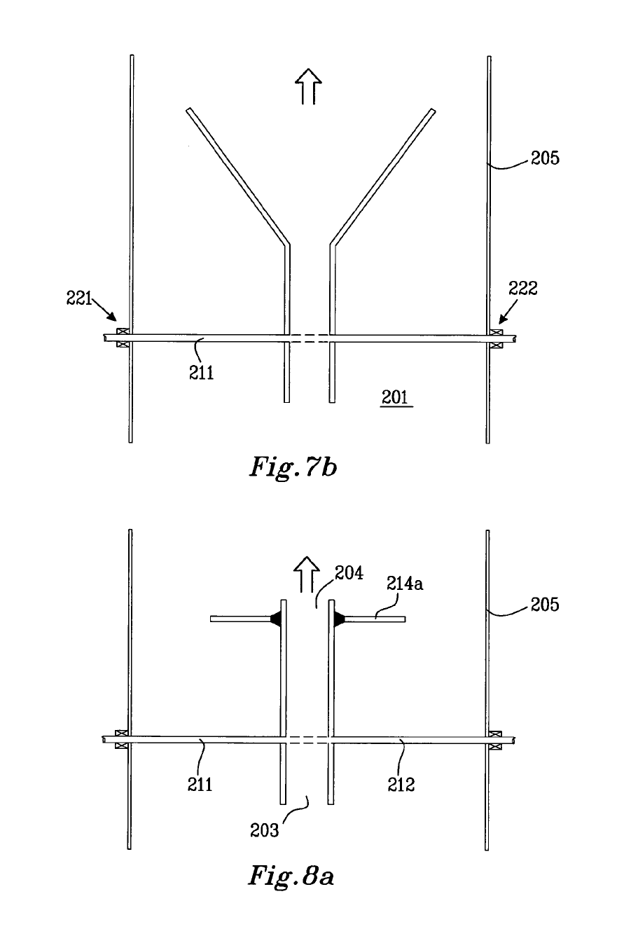

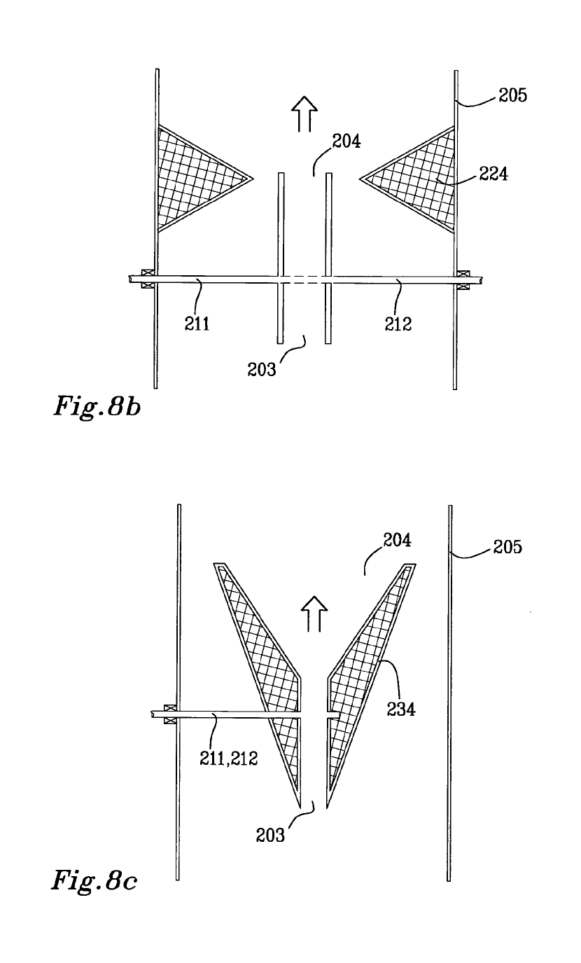

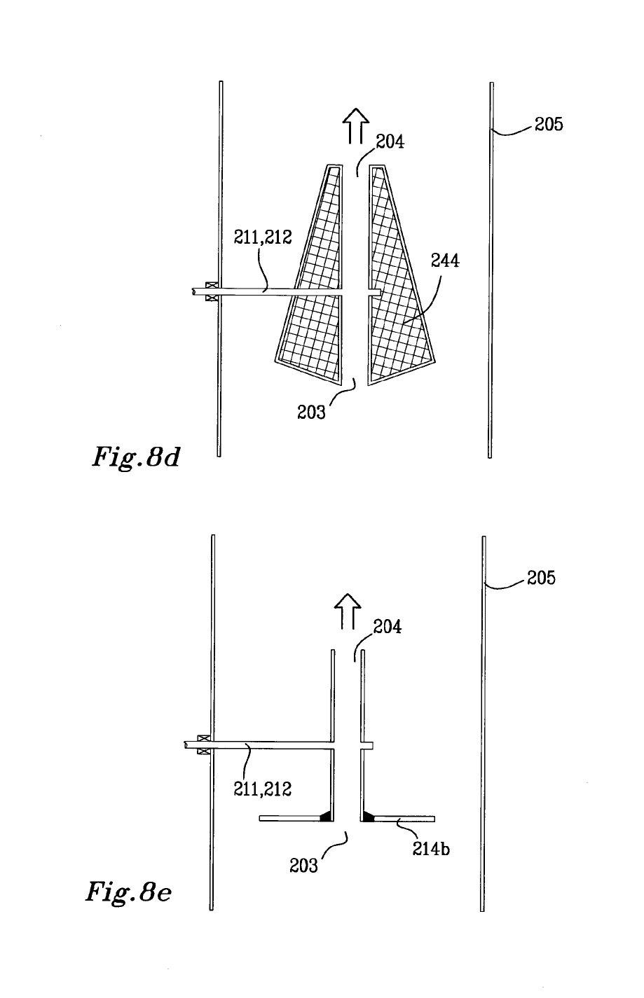

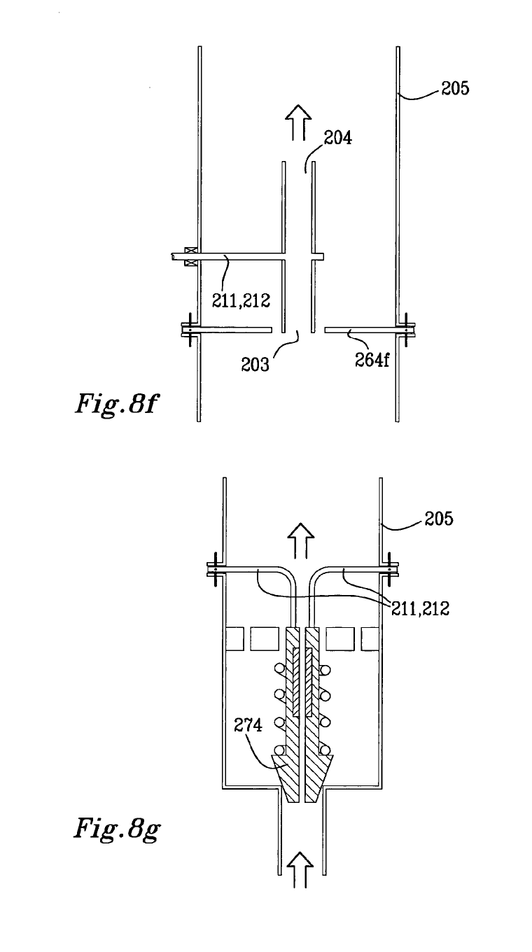

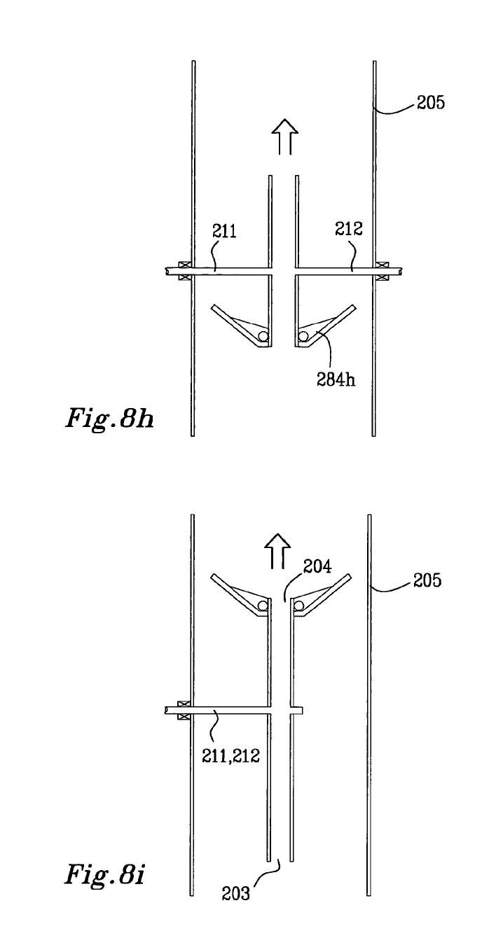

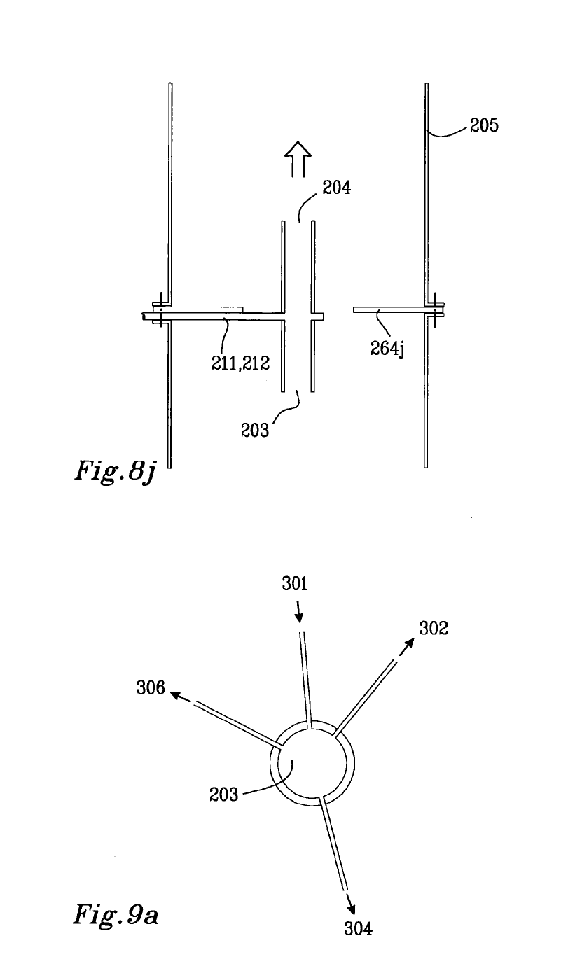

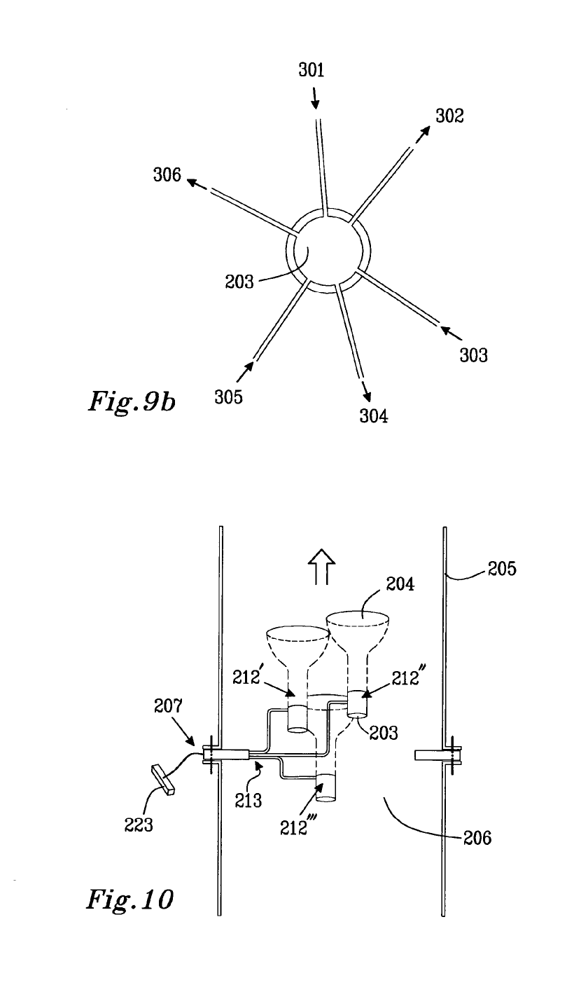

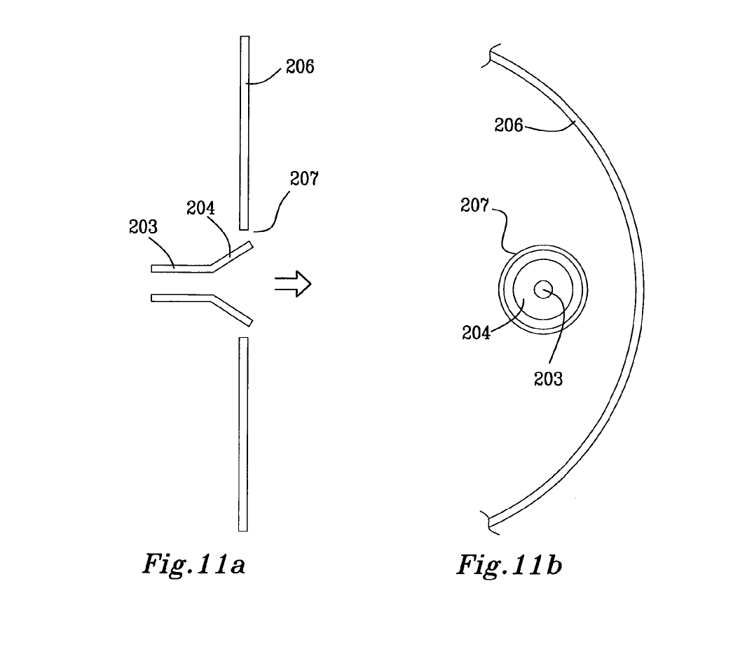

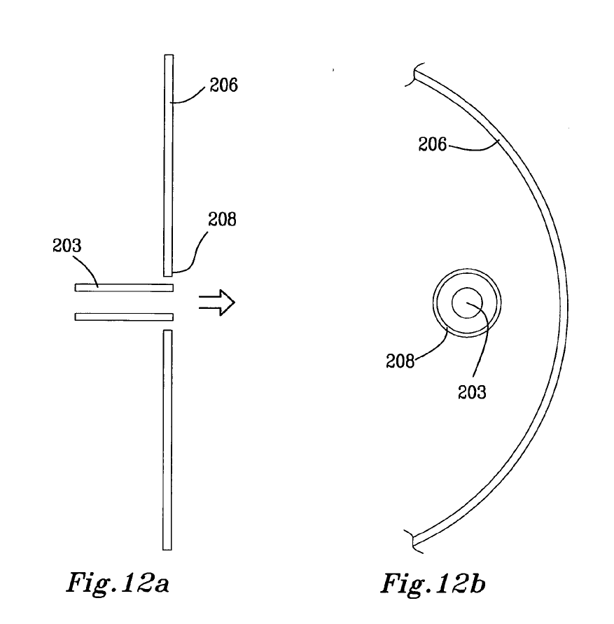

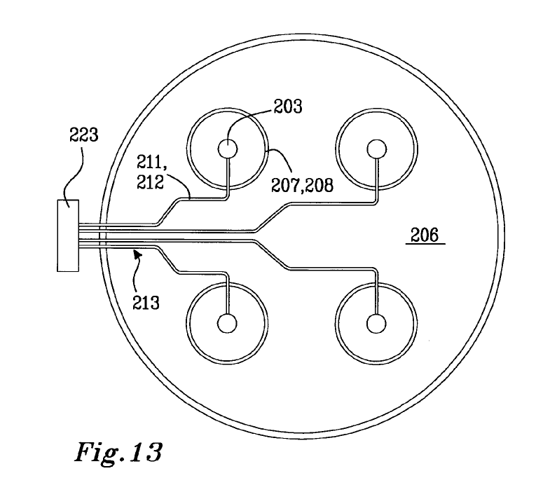

An embodiment of an apparatus 201 for inline analysis of a fluid in a conduit 205 is shown in FIG. 7a. Inline refers to that the apparatus 201 is located inline the conduit 205, i.e. inline the conduit 205. The term in-situ may also be used instead of inline. The apparatus 201 is located inside the conduit 205, in which the fluid flows in the direction indicated by the arrow. The apparatus 201 is configured to generate head loss associated with the fluid when it flows through the apparatus 201. Head loss is the reduction in total head or pressure of the fluid as it moves through the measurement arrangement. It is present because of the friction between the fluid and the walls of the conduit, the friction between adjacent fluid particles as they move relative to another, the turbulence caused whenever the flow is redirected or affected in any way by such components as piping entrances and exits, pumps, valves, flow reducers, fittings etc. The apparatus 201 may be configured to generate the head loss in many different alternative ways. The apparatus 201 comprises a flow cell 203 and a flow restriction arrangement 204. The flow cell 203 and the flow restriction arrangement 204 may be one separate parts or one common part.

The apparatus 201 has at least one optical transmission element 211 connected to it for transmitting light emitted form a light source to illuminate the apparatus 201 so that the fluid can be analysed. The apparatus 201 has also an optical receiving element 212 configured to receive the light after passing through the fluid in flow cell 203 and configured to transmit the received light so that the fluid can be analysed. The light passing through the fluid may comprise transmission backscattering, i.e. reflections, and may also comprise refraction. In the following, different example embodiments of the apparatus 201 will be described in more detail. In some embodiments, the connections 211 and 212 are optical fibres. In another embodiment, a “hard” lens-based optical system—of e.g. a periscope type—may be used as an alternative to the optical fibres. Another alternative is a hose filled up with transparent gel of required optical properties.

As seen from FIG. 7b, the apparatus 201 is positioned in the conduit 205—typically a pipe—in which the fluid flows in the direction indicated by the arrow. The fluid is here typically lubricating oil. The apparatus 201 is supported by a structure preferably not modifying the flow—not shown—, and connected to the optical transmission element 211 and the optical receiving element 212—for example optical fibres, one transmitting light emitted from a light source to the apparatus 201, the other one transmitting the measured signal out—, crossing the pipe wall at compression seal fittings 221, 222, allowing the optical transmission element 211 and the optical receiving element 212 to cross the pipe wall without leakage. The flow cell 203 has an inlet 203a and an outlet 203b through which at least a part of the fluid flows in and out.

The flow cell 203 may be a glass-made cylindrical cell, and the flow restriction arrangement 204 may be a head-loss generating unit generating additional head-loss for the fluid circulating in the pipe 205.

This flow restriction arrangement 204, here represented by a downstream—with relation to the flow cell—cone extending downstream towards the internal surface of the pipe, the conical downstream flow restriction arrangement 204 generates head-loss in the flowing fluid around the apparatus 201 by restricting the cross-sectional opening available for the flow. In addition to this head-loss applying to the fluid when flowing passed the apparatus 1, there is a local effect. At the flow restriction arrangement 204, the external fluid speed increases, and the local pressure decreases—a phenomenon used in venturis—. As a result, the local pressure at the outlet of the flow restriction arrangement 204 is lower than what could have been expected from the general head-loss calculations from such apparatus 201. After passing the apparatus 201, the flow slows down and the local pressure recovers the general conduit pressure. The pressure differential between the inlet 203a of the flow cell 203 and its outlet 203b is thus increased in such a manner that it becomes high enough to allow circulation through the small sized tubular apparatus 201. With “small”, we mean here apparatus sizes where absent, bad or unstable fluid circulations can be observed, and which need an additional head-loss to function properly. Whereas 100 μm can typically be considered small for lubrication oil and water, larger sizes should still be considered small for oil and water: 1 mm, and even several mm. Gases, other liquids, fluids with heavy particle loadings etc. may have other critical sizes requiring an extra head-loss generation.

It has been observed in the case of lubrication fluids circuits for heavy rotating machines, typically with an operating pressure of several hundred bars (up to 700 ba) and fluid velocities in the conduit in the range of 1 to 7 m/s, that a head-loss of 0.2 to 0.5 ba gave good results. These observations need confirmation and further development.

As mentioned above, the optical transmission element 211 and the optic receiving element 212 are connected the apparatus 201, conveying a light at the optical transmission element 211—typically laser light, but other lights can be used—, and conveying light transmitted through the apparatus 201 using the optic receiving element 212. The optic transmission element 211 and the optic receiving element 212 are connected to a laser light source and a particle analyser analysing the transmitted light. The laser light source and particle analyser may be locally or remotely located from the apparatus 201. The optic transmission element 211 and the optical receiving element 212 cross the pipe wall at the compression seal fittings 221, 222, (or compression glands) as known in the industry. Note that the optic transmission element 211 and the optical receiving element 212 may cross the pipe 205 at one and same compression seal fitting 221, 222.

Flow lines are represented schematically on the drawing. The flow restriction between the head-flow restriction arrangement 204 and the inner wall of the pipe 205 generates a narrowing and speed increase for the flow lines, accompanied by a reduction of pressure reaching a minimum at about the outlet 203b. The flow restriction arrangement is so designed that pressure differential between the inlet 203a and the outlet 203b is high enough to overcome the capillary and surface tension forces at the entrance of the apparatus 201 for the operation flow and fluid analysed, of which viscosity is of special relevance.

Although it will often be the case for practical reasons, the piping 205 need not be a circular pipe, but any type of conduit that can channel a circulating fluid. In fact, the conduit 205 could even be an open channel at atmospheric pressure.

The term fluid shall be interpreted in its broad sense, i.e. gas or liquid. Whereas in the described embodiment of lubrication oil monitoring, it is the identification of particles—wear metal bits, fragments of biofilms—, or the presence of other fluids—water or bubbles in oil—or both, other applications may be interested in monitoring dust in combustion smoke, ashes in the atmosphere, etc. . . . . Whereas one of the uses of the embodiments herein is to detect impurities, foreign bodies or fluids in a circulating fluid, the general purpose of such apparatus 201 is to allow inline measurement of parameters characterising the circulating fluid.

Laser light has been described in our embodiment. It can be of a single wavelength, or a composition of several wavelengths. But other types of lights can be used, such as polarised light for detection of crystallographic structures like minerals, metals, organic crystals.

The transmission means, optic fibres in our described embodiment, can also be electrical cables, and other measurements can be performed in the cell. Electromagnetic or acoustic signals (for flow measurement—electric cables would then be a natural alternative to optic fibres) etc.

The active measurement cell, e.g. the flow cell 203 strictly speaking, is preferably made of an optical transparent material, such as glass or Plexiglas. For measurement not involving a light source, the material can be different: metal, ceramics, plastic etc.

Whereas the active measurement cell, e.g. the flow cell 203 strictly speaking, is preferably prismatic (i.e. of constant cross section along its length), it needs not be so: one could for example envisage a conical flow cell 203. The flow cell 203 may also be open: for example, instead of being a tube, there might be an opening along the length of the cell, allowing exchanges between the cell and the fluid outside the cell along the fluid flow lines.

In some embodiments, and in order to obtain a laminar and stable flow, the active measurement cell, e.g. the flow cell strictly speaking, is of a certain length. However, one could install a cell of virtually zero length in the form of a ring, which function would then be limited into positioning emitter and sensor(s) with respect to each other.

Additional measurements can also be associated with the use of such cell, and/or for example optic fibres. For example, pressure and temperature can easily be measured directly by optic fibres thanks to Bragg gratings on the fibre. Whereas our example characteristic dimension for the diameter of the apparatus 201 above was 100 μm, other smaller or larger dimensions are relevant. The standards on foreign particles in hydraulic fluids focus on a range 5-100 μm. For the purpose of particle monitoring in fluids, it is thus common to introduce a 100 μm filter inline. If the apparatus 201 is of 100 μm internal diameter, foreign bodies of more than 100 μm will not flow through the measurement arrangement 201, and will thus not be measured, nor will they modify the results. Interestingly, such apparatus 201 as drawn in FIG. 7b or FIG. 8c with a downstream conical flow restriction arrangement, allows unclogging of the apparatus 201 when reversing the flow: the cone channels a large section of the circulating fluid through the smaller apparatus 201, thus enabling flushing and unclogging of the apparatus 201.

The flow restriction arrangement 204 need not be a cone, nor need it be part of the apparatus 201, and all solutions generating a local head-loss and/or flow reduction at the outlet 203b, the inlet 203a, or at any suitable locations between these two so as to generate a pressure differential between inlet 203a and outlet 203b of the apparatus 201 high enough to allow stable flow in the apparatus 201 can be considered.

FIG. 8a-j will now be described in order to illustrate alternative embodiments of the apparatus 201.

FIGS. 8a and 8e illustrate an embodiment where the flow restriction arrangement 204 comprises at least one plate 214a, 214b connected to the flow cell 203, for example welded to the flow cell 203, upstream or downstream. Even though FIGS. 8a and 8e illustrate two plates 214a, 214b, the skilled person will understand that only one plate may also be applicable. In FIG. 8a, the flow restriction element 204 is located in one end of the flow cell 203. In FIG. 8e, the flow restriction element 204 is located in the opposite end of the flow cell 203.

FIG. 8b illustrates another example embodiment of how the flow restriction arrangement 204 may be designed. In this example, the head-loss is obtained thanks to a restriction 224 in the main pipe 205. An alternative may be to install the flow restriction arrangement 204 as a perforated flange plate 264f, as illustrated about the upstream end of the flow cell 203 in FIG. 8f, or at 264j in FIG. 8j. In FIG. 8j, the perforated flange plate 264j, i.e. the flow restriction arrangement 204, is arranged at a distance from each end of the flow cell 203. In such case, the flow cell 203 itself has no inbuilt flow restriction arrangement 204. A flow restriction may also be obtained thanks to a venture shaped device installed by the outlet of the flow cell 203. The flow restriction arrangement may form a reduced flow cross-sectional area inside the conduit 205. The cross-sectional area is to be understood as being a section perpendicular to the main direction of flow/longitudinal axis of the conduit 205.

In another example embodiment, the flow restriction arrangement 204 may be designed as external conical sections assembled to generate head-loss about the downstream end at 234, see FIG. 8c, or about the upstream end, at 244 see FIG. 8d.

Other alternatives may provide adjustable head-losses, adapting for example to flow and pressure of the fluid circulating, thanks to spring-loaded devices, a central cone 274 shown in FIG. 8g, or spring-loaded check-valves, where several units can close the open section around the flow cell 203 when there is no flow, and open progressively when the fluid circulates at 284h and 284i as in FIG. 8h and FIG. 8i.

When used for light-based measurements, many configurations are possible, as described in figure 203. The embodiments herein enables single source backscattered and transmitted light analysis see FIG. 9a. The source channel 301 sends a light ray in cell 203, captures backscattered light at 302 and 306 and transmitted light at 304. As indicated in FIG. 9b, several sources can also be used at 301, 303 and 305, and backscattered and transmitted light is captured at 302, 304 and 306, and transmitted for analysis according to time multiplexing or wave filtering modes known in the art. In such case, light emission at 301, 303 and 305 can be organised so as to have sequential emission organised between the sources, or the sources may be demodulated during image analysis. With several sources distributed geometrically, a 3D image of particles can be obtained. A large number of other combinations can be considered.

Whereas some embodiment relates to the use of a single measurement cell in a conduit where the fluid to monitor circulates, other embodiments allow practical multi-cell installations.

FIG. 10 illustrates a preferred multi-cell apparatus in the form of a flange plate supporting several apparatus 201. Easy to install, without requiring specialised welders and special procedures of great interest if in an inflammable or explosive environment such as typically encountered on Oil and Gas industry plants, a plate may be provided with several measurement devices positioned for example on a uniform pattern, each connected to, for example, light transmitting and sensing optical fibres.

The measurement devices 212′, 212″ and 212′″, i.e. a plurality of apparatus 1, are fixed on a plate 206 at the level of the optic fibre connection to their respective cell. The flat structure has the same shape as the conduit (typically a disk in a pipe), and dimensions allowing the plate to participate to the flanged connection 207, in sandwich between the two conduit flanges. Optical fibres connecting to the cells are supported by the plate 213 and are directed out of the conduit preferably to a connection hub 223, thus allowing prefabrication of the measurement plate 206 and further connection to the monitoring and analysis apparatus (not represented here) via other optic fibres and standard connections.

The plate may be designed to give as little hydraulic turbulence as possible (a simple grating supporting cells and optic fibres), in which case it the conical sections of the apparatus 201 will generate required head-loss. Or it may be designed to participate to head-loss, in collaboration with the individual head-loss units—see FIG. 11a and FIG. 11b—It may even be designed to replace in their function the head-loss cones built on the cells 203—see FIG. 12a and FIG. 12b, as well as FIG. 8f.

In FIG. 11a, FIG. 11b, FIG. 12a and FIG. 12b, the plate 206 is perforated around each cell 203 at 207. The constriction generating extra head-loss in FIG. 11a and FIG. 11b results from a combination of a large perforation 207 and a head-loss cone extending towards the perforation 207. Thus, at each perforation 207, a flow cell is installed, allowing several measurements.

In FIG. 12, the constriction generating extra head-loss results from a perforation 208 (smaller with relation to 207, as there is no head-loss generating extension on the cell 203 around the cell 203.

As the apparatus 201 typically are of small dimensions, they are fragile, and it is preferable for single or multi cell devices to prefabricate them. In such case, and the solution described based on a flange plate is well adapted to that purpose, optic fibres may be fixed on or drowned in the plate material, which can be machined in order to make optional perforations and allow robust anchoring of the cells. For example plexiglass may be considered for the plate material. 3D-printing production techniques should be considered for such prefabricated measurement plates, which could look like the FIG. 13.

The apparatus 201 need not be all at the same level of the conduit 205. They may also be at different positions along the direction of the fluid. For example, one may calculate relative position of several apparatus 201 about a measurement location so as to optimise the hydraulics of the whole set.

Typically, the apparatus 201 being in the “middle” of the flow, it will capture a more representative sample than what a by-pass (biased towards the periphery of the conduit 205) would allow. When several are installed in a given section, the apparatus 201 may be spread uniformly about the section of the conduit 205, in order to have a representative measurement of the fluid. Measurements may be aggregated (for example results of the different flow cells can be averaged) or individualised if distribution in the conduit is of interest. In order to enhance homogeneity (and for example avoid particles at the lower part of the conduit), static mixers or mixers can be added upstream.

The embodiments herein are not limited to the above described embodiments. Various alternatives, modifications and equivalents may be used. Therefore, the above embodiments should not be taken as limiting the scope of the embodiments, which is defined by the appending claims.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

It should also be emphasised that the steps of the methods defined in the appended claims may, without departing from the embodiments herein, be performed in another order than the order in which they appear in the claims.

1. A system for analyzing a fluid, the system comprising:
a light source configured to emit light for transmission through a first optical transmission means to at least one measurement device, the at least one measurement device including at least a part of the fluid and being configured to be illuminated by the emitted light;
a second optical transmission means configured to transmit shadowed or reflected light from the fluid when the at least one measurement device is illuminated to one or more image capturing device, the one or more image capturing device being configured to capture an image of the fluid in the measurement device based on the transmitted information about the fluid; and
the light source and the one or more image capturing device being remotely arranged from the at least one measurement device.

2. The system according to claim 1, further comprising an analysing device configured to analyse the captured image thereby obtaining information about the fluid.

3. The system according to claim 1, wherein the at least one measurement device is a flow cell connected to at least one machine comprising the fluid, and wherein the fluid comprised in the machine is bypassed through the at least one flow cell.

4. The system according to claim 3, wherein the at least one flow cell comprises a first part to which the first optical transmission means is connected and through which the emitted light is further transmitted when the at least one flow cell is illuminated.

5. The system according to claim 4, wherein the first part is a first transparent sheet.

6. The system according to claim 1, wherein at least a part of the first optical transmission means and at least a part of the second optical transmission means comprises at least one optical fiber cable for each measurement device.

7. The system according to claim 3, wherein the one or more image capturing device comprises one image sensor associated with each optical fiber cable and each measurement device, wherein the image sensor is adjusted to capture shadowed or reflected light transmitted through the associated optical fiber cable and configured to assign the captured shadowed or reflected light to the respective measurement device from which the shadowed or reflected light is transmitted.

8. The system according to claim 3, wherein the one or more image capturing device comprises one High Definition image sensor divided into a number of spatial areas respectively associated with an optical fiber cable, wherein the High Definition image sensor is arranged so that the each spatial area is associated with captured shadowed or reflected light transmitted through the optical fiber cable and wherein the High Definition image sensor is configured to assign the captured shadowed or reflected light to the respective measurement device from which the shadowed or reflected light is transmitted.

9. The system according to claim 3, wherein the at least one optical fiber cable is provided with an optical switch being synchronized with the frame rate of the one or more image capturing devices, the optical switch is switched on only when the one or more image capturing device is capturing a certain frame in an array of captured frames during an image capturing cycle, and the captured image data in the certain frame only comprises image data of shadowed or reflected light transmitted through the optical fiber cable, which is being assigned to the at least one measurement device from which the shadowed or reflected light is transmitted.

10. The system according to claim 1, wherein each of the first optical transmission means and second optical transmission means comprises uplink optical transmission means and downlink transmission means, and wherein both the uplink optical transmission means and the downlink optical transmission means are connected to a first part such that the uplink optical transmission means are configured to capture light reflecting from particles in the measurement device, and wherein a wavelength of the reflected light can be used as an indication for determining a type of material in the particles reflecting the light.

11. The system according to claim 10, wherein the uplink optical transmission means are arranged so as to have different angles relative to the first part.

12. The system according to claim 3, wherein the emitted light travels through the fluid when illuminating the at least one flow cell, and wherein the information about the fluid is based on a property of the emitted light when travelling through the fluid.

13. The system according to claim 1, wherein the fluid comprises at least one of particles and impurities and wherein the information about the fluid comprises information about at least one of:
a number of at least one of particles and impurities in the fluid; and
at least one of the type of particles and the type of impurities in the fluid.

14. The system according to claim 1, wherein the fluid is a liquid or a gas.

15. The system according to claim 1,
wherein the at least one measurement device comprises a flow cell formed with a fluid inlet and a fluid outlet through which at least a part of the fluid flows in and out, a flow restriction arrangement, whereby the flow restriction arrangement is configured to generate an increased head-loss between the fluid inlet and the fluid outlet; and
wherein the at least one measurement device is connected to the first optical transmission means configured to transmit light emitted from the light source to pass through at least a section of the fluid flowing through the flow cell and connected to the second optical transmission means configured to receive the light after passing through the fluid in flow cell and configured to transmit the received light to an analyser so that the fluid can be analysed.

16. (canceled)

17. (canceled)

18. (canceled)

19. (canceled)

20. The system according to claim 15, wherein the flow restriction arrangement is configured to generate head-loss in the range of 0.3 to 0.5 ba.

21. (canceled)

22. (canceled)

23. (canceled)

24. (canceled)

25. A method for analyzing a fluid, the method comprising:
emitting light from a light source;
transmitting the emitted light through a first optical transmission means to at least one measurement device, which at least one measurement device comprises at least a part of the fluid;
illuminating the at least one measurement device with the transmitted light; and
transmitting shadowed or reflected light from the fluid when the at least one measurement device is illuminated to one or more image capturing device using a second optical transmission means, wherein the one or more image capturing device is configured to capture an image of the fluid in the measurement device based on the transmitted information about the fluid; and
wherein the light source and the one or more image capturing device are remotely arranged from the at least one measuring device.

26. The method according to claim 25, further comprising analyzing the captured image with an analyser thereby obtaining information about the fluid.

27. The method according to claim 25, wherein the at least one measurement device is a flow cell connected to at least one machine comprising the fluid, and wherein the fluid comprised in the machine is bypassed through the at least one flow cell.

28. The method according to claim 27, wherein the at least one flow cell comprises a first part to which the first optical transmission means is connected and through which the emitted light is further transmitted when the at least one flow cell is illuminated.

29. The method according to claim 28, wherein the first part is a first transparent sheet.

30. The method according to claim 25, wherein at least a part of the first optical transmission means and at least a part of the second optical transmission means comprises at least one optical fiber cable for each measurement device.

31. The method according to claim 30, wherein the one or more image capturing device comprises one image sensor associated with each optical fiber cable and each measurement device, wherein the image sensor is adjusted to capture shadowed or reflected light transmitted through the associated optical fiber cable and assigning the captured shadowed or reflected light to the measurement device from which the shadowed or reflected light is transmitted.

32. The method according to claim 30, wherein the one or more image capturing device comprises one High Definition image sensor divided into a number of spatial areas respectively associated with an optical fiber cable, wherein the High Definition image sensor is arranged so that each spatial area only captures shadowed or reflected light transmitted through the optical fiber cable and wherein the High Definition image sensor is configured to assign the captured shadowed or reflected light to the measurement device from which the shadowed or reflected light is transmitted.

33. The method according to claim 30, further comprising:
synchronizing an optical switch with which at least one optical fiber cable is provided with the frame rate of the one or more image capturing device;
switching on the optical switch only when the one or more image capturing device is capturing a certain frame in an array of captured frames during an image capturing cycle of the one or more image capturing device; and
assigning the measurement device from which the shadowed or reflected light is transmitted to the captured image data in the certain frame.

34. The method according to claim 25, wherein each of the first optical transmission means and second optical transmission means comprises uplink optical transmission means and downlink transmission means, and wherein both the uplink optical transmission means and the downlink optical transmission means are connected to a first part such that the uplink optical transmission means are configured to capture light reflecting from particles in the measurement device, and wherein a wavelength of the reflected light can be used as an indication for determining a type of material in the particles reflecting the light.

35. The method according to claim 34, wherein the uplink optical transmission means are arranged so as to have different angles relative to the first part.

36. The method according to claim 25, wherein the emitted light travels through the fluid when illuminating the at least one flow cell, and wherein the information about the fluid is based on a property of the emitted light when travelling through the fluid.

37. The method according to claim 25, wherein the fluid comprises at least one of particles and impurities and wherein the information about the fluid comprises information about at least one of:
a number of at least one of particles and impurities in the fluid; and
at least one of the type of particles and the type of impurities in the fluid.

38. The method according to claim 25, wherein the fluid is a liquid or a gas.

39. The method according to claim 25, wherein
the measurement device comprises a flow cell formed with a fluid inlet and a fluid outlet through which at least a part of the fluid flows in and out,
a flow restriction arrangement whereby, the flow restriction arrangement is configured to generate an increased head-loss between the fluid inlet and the fluid outlet, and
wherein the measurement device is connected to the first optical transmission means configured to transmit light emitted from a light source to pass through at least a section of the fluid flowing through the flow cell and connected to the second optical transmission means configured to receive the light after passing through the fluid in flow cell and configured to transmit the received light to an analyser so that the fluid can be analysed.

40. A computer program stored in a computer readable memory and comprising instructions to execute the method according to claim 25.

41. An apparatus for analysing a fluid flowing through a conduit, which apparatus is located within the conduit, the apparatus comprising:
a flow cell formed with a fluid inlet and a fluid outlet through which a part of the fluid in the conduit flows in and out,
a flow restriction arrangement whereby, the flow restriction arrangement is configured to generate an increased head-loss between the fluid inlet and the fluid outlet, and
wherein the apparatus located within the conduit further comprises at least one optical transmission element configured to transmit light emitted from a light source to pass through at least a section of the fluid flowing through the flow cell and at least one optical receiving element configured to receive the light after passing through the fluid in flow cell and configured to transmit the received light to an analyser so that the fluid can be analysed.

42. The apparatus according to claim 41, wherein at least a part of the flow restriction arrangement is connected to the flow cell.

43. The apparatus according to claim 41, wherein at least a part of the flow restriction arrangement is connected to the conduit.

44. (canceled)

45. (canceled)

46. The apparatus according to claim 41, wherein the flow restriction arrangement is configured to generate head-loss in the range of 0.3 to 0.5 ba.

47. (canceled)

48. (canceled)

49. (canceled)

50. (canceled)

51. A conduit comprising a fluid and at least one apparatus located within the conduit according to claim 41.

52. A measurement system comprising an apparatus according to claim 41.

53. A method for analysis of a fluid in a conduit using an apparatus, the apparatus being located in the conduit, the apparatus comprising a flow cell formed with a fluid inlet and a fluid outlet, and the apparatus located within the conduit further comprising a flow restriction arrangement, at least one optical transmission element and at least one optical receiving element, the method comprising:
generating an increased head loss between the fluid inlet and the fluid outlet when a part of the fluid in the conduit flows through the apparatus;
transmitting light emitted from a light source through the at least one optical transmission element so that it passes through at least a section of the fluid flowing through the flow cell;
receiving, with the at least one optical receiving element, the light after passing through the fluid in the flow cell; and
transmitting, using the at least one optical receiving element, the received light to an analyser so that the fluid can be analyzed.

54. The method according to claim 53, wherein the at least one optical transmission element and the at least one optical receiving element are optical fibres.
